(19) United States
(12) Patent Application Publication
(10) Pub. No.: US 2011/0185508 A1
(43) Pub. Date: Aug. 4, 2011

(54) Prevention and Treatment of Pressure Sores Using a Sheet with an Integrated Inflatable Component

(76) Inventors: Charles Hsu, Palo Alto, CA (US); Chienlan Hsu, Palo Alto, CA (US); Kenton Fong, Mountain View, CA (US)

(21) Appl. No.: 12/698,981

(22) Filed: Feb. 2, 2010

(51) Int. Cl. A61G 7/057; A47C 27/08; A47G 9/02

(52) U.S. Cl. 5/706

(57) ABSTRACT

A sheet to be positioned under a patient to treat or mitigate formation of pressure sores includes a first layer of sheeting and an inflatable component secured to the first layer of sheeting. The inflatable component at least partially encloses a region exterior to the inflatable component and will relieve pressure from a portion of the patient's body when the region that the inflatable component at least partially encloses is positioned under the portion of the patient's body and the inflatable component is inflated.

### TECHNICAL FIELD

The disclosed embodiments relate generally to treating and preventing pressure sores, and more particularly, to a sheet with an integrated inflatable component for treating and preventing pressure sores.

### BACKGROUND

Pressure sores, also referred to as bed sores, pressure ulcers, or decubitus ulcers, are a major health care problem. These sores arise in general acute care, long-term care, and home care populations. Minimally mobile patients (e.g., ICU, spinal cord injury, elderly, and terminally ill patient populations) have the highest risk for developing pressure sores.

The development of pressure sores is primarily due to decreased blood flow to the tissues over areas of bony prominences on the body. For supine patients, sores can develop over the sacrum, heels, and back of the head. For sitting patients, sores can develop over the ischial tuberosities. For patients turned on their sides, sores can develop over the greater trochanters, hips, ankles, and knees. In any position, pressure sores can develop in any areas where there is prolonged pressure that interferes with normal blood flow into the tissue.

Intermittent pressure relief can prevent pressure sores from occurring. For example, patients who are unable to reposition themselves are sometimes required to be repositioned every two hours by nursing staff, in order to shift the pressure points. Although effective, manually repositioning patients is labor intensive and may cause back injuries in medical staff. Many institutions do not have sufficient staff to perform repositioning in a timely fashion. Specialized mattresses and cushions can provide some relief, but also have limitations in terms of efficacy, cost, and workflow. Complicated techniques of achieving intermittent pressure relief may be unfeasible for the workflow of normal nursing care. Also, devices for achieving intermittent pressure relief should not interfere with patient access during nursing care.

### SUMMARY

In some embodiments, a sheet to be positioned under a patient to treat or mitigate formation of pressure sores includes a first layer of sheeting and an inflatable component secured to the first layer of sheeting. The inflatable component at least partially encloses a region exterior to the inflatable component and will relieve pressure from a portion of the patient's body when the region that the inflatable component at least partially encloses is positioned under the portion of the patient's body and the inflatable component is inflated.

In some embodiments, a system to provide pressure relief to a portion of a patient's body to treat or mitigate formation of pressure sores includes a sheet to be positioned under the patient. The sheet includes a first layer of sheeting and an inflatable component secured to the first layer of sheeting. The inflatable component at least partially encloses a region exterior to the inflatable component. The inflatable component will relieve pressure from the portion of the patient's body when the region that the inflatable component at least partially encloses is positioned under the portion of the patient's body and the inflatable component is inflated. The system also includes tubing coupled to the inflatable component. The system further includes a pump, coupled to the tubing, to inflate and deflate the inflatable component.

In some embodiments, a method of providing pressure relief to a portion of a patient's body to treat or mitigate formation of pressure sores is performed. In the method, a sheet is positioned under the patient. The sheet includes a first layer of sheeting and an inflatable component. The inflatable component is secured to the first layer of sheeting and at least partially encloses a region exterior to the inflatable component. Positioning the sheet under the patient includes positioning the at least partially enclosed region under the portion of the patient's body. The inflatable component is coupled to a pump and repeatedly inflated and deflated.

### BRIEF DESCRIPTION OF THE DRAWINGS

FIGS. 1A and 1B are angled views of sheets with an integrated inflatable component in accordance with some embodiments.

FIG. 2 is a plan view of a sheet with an integrated inflatable component and with markings that indicate how to position the sheet with respect to the patient, in accordance with some embodiments.

FIGS. 3A-3C are side views of sheets with an inflatable component situated between layers of sheeting in accordance with some embodiments.

FIG. 4 is a schematic illustration of a system that includes a source component (e.g., an air pump or water pump) coupled to a sheet through tubing in accordance with some embodiments.

FIGS. 5A-5C are plan views of examples of inflatable components in accordance with some embodiments.

FIGS. 6A and 6B are block diagrams illustrating systems in which a source component provides inflation to both an inflatable component of a sheet and to a sequential compression device in accordance with some embodiments.

FIGS. 7A and 7B are block diagrams illustrating systems in which tubing couples an inflatable component to both a source component and a suction component in accordance with some embodiments.

FIG. 8 is a flow diagram illustrating a method of providing pressure relief to a portion of a patient's body to treat or mitigate formation of pressure sores in accordance with some embodiments.

Like reference numerals refer to corresponding parts throughout the drawings.

### DESCRIPTION OF EMBODIMENTS

Reference will now be made in detail to various embodiments, examples of which are illustrated in the accompanying drawings. In the following detailed description, numerous specific details are set forth in order to provide a thorough understanding of the present inventions. However, it will be apparent to one of ordinary skill in the art that the present inventions may be practiced without these specific details. In other instances, well-known methods, procedures, components, and circuits have not been described in detail so as not to unnecessarily obscure aspects of the embodiments.

In some embodiments, an inflatable component allows for intermittent relief of pressure on a specific portion of the body that is at high risk for pressure sore development. The inflatable component thus helps to prevent, reduce, or otherwise mitigate the development of pressure sores and treats existing pressure sores by relieving pressure such that the sores can better heal. To ease positioning of the inflatable component, the inflatable component is integrated into a sheet, sometimes referred to as a draw sheet, to be positioned underneath a patient. Integration of the inflatable component with the sheet increases the compatibility of the inflatable component with standard nursing practices and thus provides convenience with respect to nursing work flow, as well as minimizing intrusiveness of the inflatable component. The sheet is positioned between the patient and the bed or other structure (e.g., chair) supporting the patient. The inflatable component is attached via tubing to a source component (e.g., an air pump or water pump) that provides intermittent inflation and deflation. The intermittent inflation and deflation provided by the source component allow the inflatable component repeatedly to elevate the high-risk body portion off of the underlying surface, without exerting direct pressure on the high-risk body portion. The inflatable component thus intermittently relieves pressure to the high-risk body portion, allowing perfusion and thereby decreasing the risk of pressure sore development or allowing existing pressures sores to heal.

Examples of high-risk body portions that the inflatable component can be designed to accommodate, and for which it is thus configured to reduce pressure, include but are not limited to: sacrum, heels, ischial tuberosities, iliac spines, greater trochanters, scapulae, and occiput. The inflatable component may be used for portions of the body at high risk depending on patient positioning. For example, in the prone position high-risk body portions include but are not limited to: sternum, rib cage, knees, toes, or shoulders. As another example, in the lateral decubitus position, high-risk body portions include but are not limited to: ankles, knees, greater trochanters, shoulders, and ears.

In some embodiments, the inflatable component has a single set of one or more inflatable cells that are all inflated and deflated in synchrony, thus providing a simple design that avoids the complexity of two or more sets of inflatable components that are inflated and deflated in an alternating or otherwise asynchronous manner. Alternately, the inflatable component has two or more sets of inflatable components that may be individually inflated and deflated. For example, in some embodiments the inflatable component includes first and second independently inflatable cells. The first cell is inflated while the second cell is deflated to tilt the patient. In some embodiments the inflatable component includes multiple independently inflatable cells, and the number of cells that are inflated is varied to provide varying degrees of pressure relief or control over patient positioning. For example, additional cells could be inflated (e.g., as a function of pressure) to provide additional force to elevate a body portion of an obese patient as compared to a lighter patient. In other words, fewer cells are used to elevate a body portion of a light-weight patient as opposed to an obese patient.

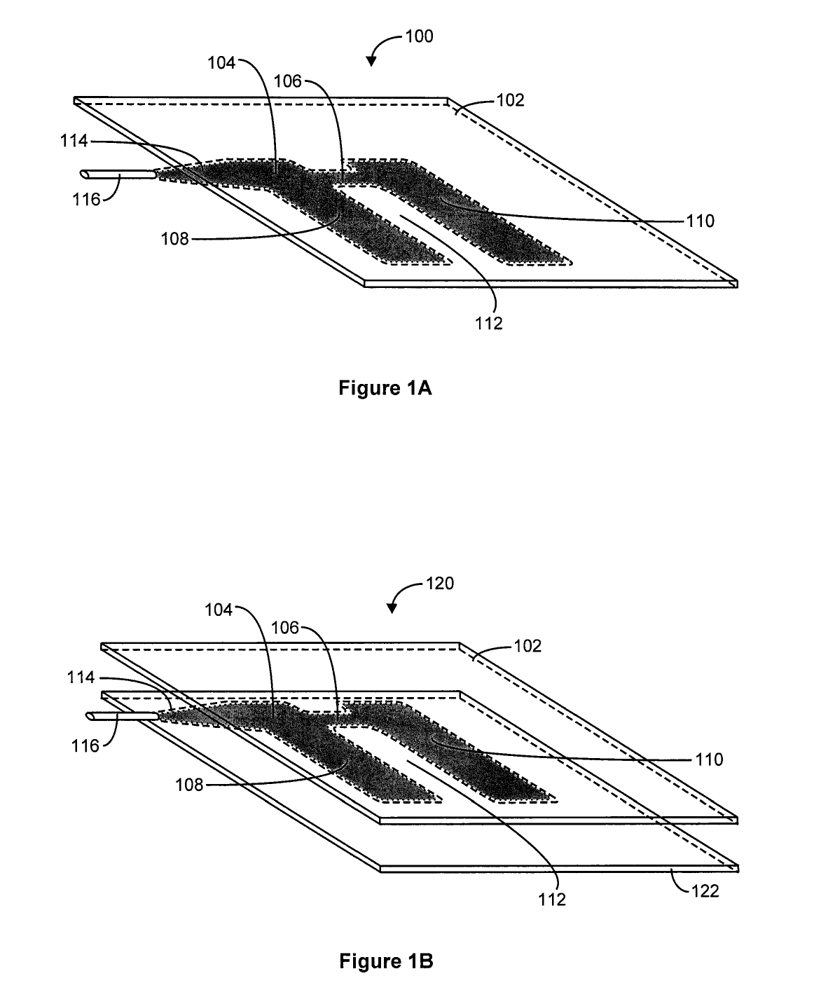

FIG. 1A is an angled view of a sheet 100 with an integrated inflatable component 104 in accordance with some embodiments. The sheet 100 includes a first layer of sheeting 102. The inflatable component 104 is secured to the first layer of sheeting 102. For example, the inflatable component 104 is adhesively attached to the first layer of sheeting 102, is sewn onto the first layer of sheeting 102, or is detachably attached to the first layer of sheeting 102 using a hook-and-loop material or other appropriate material. In some embodiments, the inflatable component 104 is secured to the first layer of sheeting 102 such that it is flush against the first layer 102 when deflated. The inflatable component 104 at least partially encloses a region 112 exterior to the inflatable component 104. In other words, the region 112 is an opening that is at least surrounded by the inflatable component 104. The opening (i.e., the region 112) is an opening between portions of the inflatable component 104 and does not imply an opening in the first layer of sheeting 102, which in some embodiments continuously covers the region 112, or in any other layer of sheeting. When the sheet 100 is positioned under the patient such that the region 112 (i.e., the at least partially enclosed region 112) is positioned under a portion of a patient's body at risk for formation of pressure sores and the inflatable component 104 is inflated, pressure is relieved from the at-risk portion of the patient's body.

Securing the inflatable component 104 to the first layer of sheeting 102 fixes the position of the inflatable component 104 with respect to the first layer 102 such that the inflatable component 104 is effectively pre-aligned: if the sheet 100 is properly positioned under the patient, the region 112 will automatically be positioned under the body portion at risk for pressure sores.

FIG. 1B is an angled view of a sheet 120 with an integrated inflatable component 104 in accordance with some embodiments. In addition to the first layer of sheeting 102 and the inflatable component 104, the sheet 120 includes a second layer of sheeting 122. The inflatable component 104 is situated between the first layer 102 and second layer 122 and is secured to (e.g., attached to) at least one of the layers 102 and 122. For visual clarity, the first and second layers 102 and 122 are shown in FIG. 1B as being separated; in practice, the first and second layers 102 and 122 are connected to form a single sheet 120. For example, the first and second layers 102 and 122 are attached at the edges of the sheet 120.

In some embodiments, the first layer 102 and/or second layer 122 of sheeting are made from a textile material (e.g., cotton), rubber, a blend of cotton and rubber, vinyl, polyester, a rayon/polyester blend, a cotton/polyester blend, fleece, or wool. In some embodiments, the first layer 102 and/or second layer 122 of sheeting is an incontinence sheet. The incontinence sheet includes, for example, a polyester film backing, a layer of absorbent material (e.g., fluff pulp), and a thin layer of paper tissue over the layer of absorbent material; the thin layer of paper tissue is to be positioned against the patient. In some embodiments, the inflatable component 104 is made from a nonelastic, noncompliant material that inflates without deforming, thus allowing the inflatable component 104 to maintain the outline of its shape (e.g., in plan view) when inflated. For example, the inflatable component 104 is made from vinyl, silicone, or plastic (e.g., polyurethane). In some embodiments, the inflatable component 104 is configured to smoothly flatten against the sheet upon deflation when the sheet is positioned underneath a patient, thus avoiding formation of folds or wrinkles that could press against the patient's skin, causing discomfort and possibly contributing to the development of pressure sores.

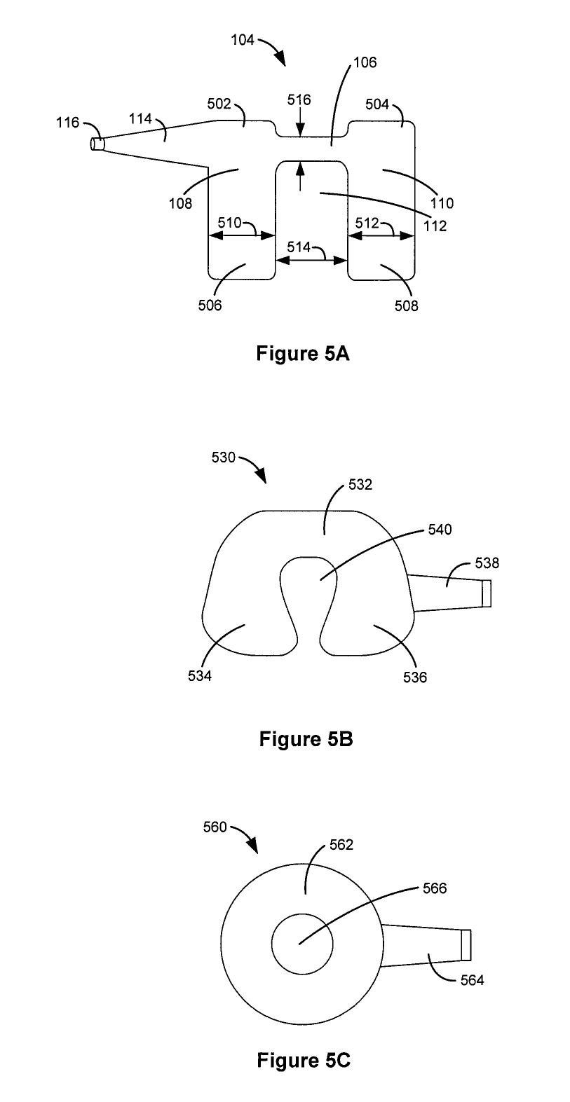

In the examples of FIGS. 1A and 1B, the inflatable component 104 has an “H” shape formed by a lateral segment 106 that connects a first longitudinal segment 108 to a second longitudinal segment 110. The lateral segment 106, first longitudinal segment 108, and second longitudinal segment 110 partially enclose the region 112, which for example is shaped to accommodate the patient's sacrum, such that pressure is off-loaded from the sacrum when the inflatable component 104 is inflated. As further illustrated in FIG. 5A, the first longitudinal segment 108 includes a first portion 502 that extends longitudinally above the lateral segment 106 and a second portion 506 that extends longitudinally below the lateral segment 106. Similarly, the second longitudinal segment 110 includes a first portion 504 that extends longitudinally above the lateral segment 106 and a second portion 508 that extends longitudinally below the lateral segment 106. The lateral segment 106 and second portions 506 and 508 thus partially enclose the region 112. In some embodiments, the inflatable component 104 has rounded corners for patient comfort.

Dimensions of the inflatable component 104 may be selected to reduce, minimize, or prevent arching of the back when the inflatable component 104 is inflated, and thus to reduce, minimize, or prevent lordosis pain. For example, lordosis pain is reduced by designing the height 516 (indicated in FIG. 5A by opposing arrows) of the lateral component 106 to be less than the widths 510 and 512 of the first and second longitudinal segments 108 and 110. In some embodiments, the height 516 is at least one inch less than the widths 510 and 512. For example, the height 516 is less than or equal to 3 inches (e.g., is between 1 and 3 inches) and the widths 510 and 512 are greater than or equal to 4 inches (e.g., are between 4 and 6 inches, or between 4 and 10 inches). In one example, the height 516 is 1 inch and the widths 510 and 512 are 6 inches. In another example, the height 516 is 1.25 inches and the widths 510 and 512 are 5.5 inches.

The width 514 of the lateral segment 516, which is also the width of the region 112 and the separation between the second portions 506 and 508, is selected to be wide enough to accommodate the sacrum but not so wide that the sacrum is not elevated upon inflation. In some embodiments, the width 514 is greater than or equal to one inch and less than or equal to six inches. In some embodiments, the width 514 is greater than or equal to two inches and less than or equal to four inches. For example, the width 514 is 2 inches, or 2.5 inches.

In some embodiments, the inflatable component 104 also includes a segment 114 that extends from the first longitudinal segment 108 to the side edge of the sheet 100 (FIG. 1A) or 120 (FIG. 1B). The segment 114 connects to an attachment 116 that can be attached to tubing that couples the inflatable component 104 to a pump used to inflate and deflate the inflatable component 104. Alternatively, the segment 114 is absent and the attachment 116 extends from the portion 108 to the edge of the sheet 100 (FIG. 1A) or 120 (FIG. 1B), where the attachment 116 can be attached to the tubing that couples the inflatable component 104 to the pump. In yet another alternative, the segment 114 is absent and the tubing extends from the portion 108 to the edge of the sheet 100 (FIG. 1A) or 120 (FIG. 1B) and on to the pump.

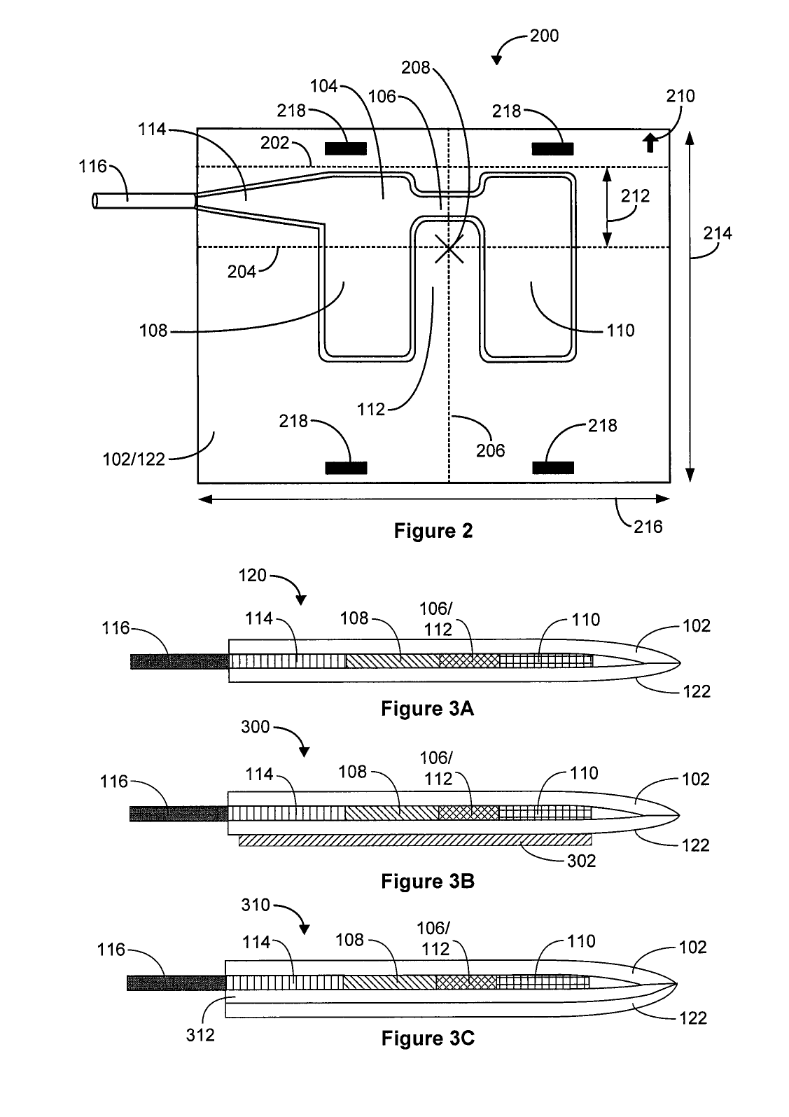

FIG. 2 is a plan view of a sheet 200 with markings 202, 204, 206, 208, and 210 that indicate how to position the sheet 200 with respect to the patient, in accordance with some embodiments. While the sheet 200 is illustrated as having all five markings 202, 204, 206, 208, and 210, in some embodiments a sheet includes any one or more of the five markings 202, 204, 206, 208, and 210 in any combination, and each marking may appear on either or both sides of the sheet.

The marker 208 (e.g., an “X,” or alternatively a star, circle, arrow, line, or other appropriate symbol) indicates an area in the region 112 (i.e., the region or opening at least partially enclosed by the inflatable component 104) to be positioned under a portion of the patient's body at risk for bed sores (e.g., under the patient's sacrum).

The marking 202 is a line extending laterally across the sheet 200 to be aligned to the patient's anterior superior iliac spine (ASIS), which is the anterior extremity of the iliac crest of the pelvis and can be felt externally. A nurse can feel the patient's ASIS and then align the line 202 to the patient's ASIS by positioning the patient's ASIS directly over the line 202. The line 202 has a location on the sheet 200 with respect to the region 112 that allows the region 112 to be aligned to the patient's sacrum when the line 202 is aligned to the patient's ASIS. Specifically, the line 202 is located a longitudinal distance 212 above a point (e.g., a point corresponding to the area indicated by the marking 208) in the region 112 to be positioned under the patient's sacrum. The distance 212 corresponds to an approximate longitudinal distance between the ASIS and the sacrum. For example, the distance 212 is an average distance between the ASIS and the sacrum, or another distance within the statistical population of distances between the ASIS and the sacrum, such that when a patient's ASIS is aligned to the line 202, the patient's sacrum is aligned longitudinally to the opening 112. In some embodiments, the distance 212 is 3 inches, or 2.8-3.2 inches, or 2-4 inches.

In some embodiments, the sheet 200 includes a line 204 extending laterally across the sheet 200 through the region 112. For example, the line 204 intersects the area indicated by the marking 208. In some embodiments, the sheet 200 includes both the line 202 and 204, with the lines 202 and 204 separated by the longitudinal distance 212 corresponding to an approximate longitudinal distance between the ASIS and the sacrum.

In some embodiments, the sheet 200 includes a line 206 extending longitudinally across the sheet 200 through the region 112. For example, the line 206 intersects the area indicated by the marking 208. Positioning the line 206 beneath the middle of the patient's back and between the patient's legs ensures that the region 112 is aligned laterally to the patient's sacrum. In other words, the line 206 can be aligned to the patient's sacrum such that the portion of the line 206 passing through the region 112 is underneath the patient's sacrum when the patient is positioned over the sheet 200.

The lines 202, 204, and 206 extend across the entire width or length of the sheet 200, or alternatively extend across only a portion of the width or length of the sheet 200. In either case, the lines 202, 204, and 206 are said to extend across the sheet.

In some embodiments, the sheet 200 includes an orientation marker 210 that indicates the proper orientation of the sheet with respect to the patient. For example, the marker 210 indicates the side of the sheet 200 to be positioned in the direction of the patient's head, or alternatively the side to be positioned in the direction of the patient's feet or right or left side. Examples of a marker 210 include an arrow (e.g., indicating the side to be positioned in the direction of the patient's head), a picture of a person (e.g., a stick figure) showing the proper orientation of the sheet 200, or text (e.g., “This Side Up”) indicating the proper orientation of the sheet 200.

In some embodiments, one or more of the markings 202, 204, 206, 208, and 210 are removably adjustable: they can be removed from the sheet 200 and then reattached to the sheet 200 in different locations, to allow for patient-specific customization of the markings. For example, the markings 202, 204, 206, 208, and/or 210 may be felt markings that can be removably attached to the sheet 200 using a hook-and-loop material or other suitable connection.

In some embodiments, the sheet 200 has a width 216 (i.e., a lateral dimension, corresponding for example to the side-to-side direction of a bed when the sheet 200 is properly oriented on the bed) of at least 80 cm, or at least 90 cm, or at least 100 cm. In some embodiments, the sheet 200 has a length 214 (i.e., a longitudinal dimension, corresponding for example to the top-to-bottom direction of a bed when the sheet 200 is properly oriented on the bed) of at least 50 cm, or at least 60 cm, or at least 100 cm. In some embodiments, the sheet 200 has a width 216 of at least 80 cm and a length 214 of at least 50 cm, or a width 216 of at least 90 cm and a length 214 of at least 60 cm, or a width 216 of at least 90 cm and a length 214 of at least 90 cm. In some embodiments, the width 216 is 90 cm and the length 214 is 66 cm. In some embodiments, the width 216 is 90 cm and the length 214 is 110 cm. In some embodiments, the width 216 corresponds to the width of a twin bed.

In some embodiments, the sheet 200 includes one or more attachments 218 to attach the sheet 200 to an external structure (e.g., a bed or wheelchair) for supporting the patient. For example, the sheet 200 includes strips 218 of hook-and-loop material to attach to appropriately positioned strips on the external structure. In other examples, the sheet 200 includes ties, strings, or straps to attach the sheet 200 to the external structure. Attaching the sheet 200 to the external structure allows the patient, if sufficiently mobile, to position himself over the sheet (e.g., with the aid of one or more markings 202, 204, 206, 208, and 210) such that the region 112 is positioned over a body portion at risk for pressure sores. The patient thus can position himself on the sheet 200 without the assistance of a nurse.

FIG. 3A is a side view, or cross section, of the sheet 120 of FIG. 1B in accordance with some embodiments. The segments 114, 108, 106, and 110 of the inflatable component 104 are situated between the first layer of sheeting 102 and the second layer of sheeting 104. The region 112 that the inflatable component 104 partially encloses is covered by the first layer 102 and second layer 122. In some embodiments, the second layer 122 is the same size, or in other words has the same dimensions, as the first layer 102. Alternatively, the length and/or width of the second layer 122 are smaller than the length and/or width of the first layer 102. In some embodiments, the second layer 122 is attached to the first layer 102 to form a pocket in which the inflatable component 104 is situated; the pocket secures the inflatable component 104 to the first layer 102. Alternatively, as shown in FIG. 3C, a sheet 310 includes a third layer of sheeting 312 attached to the first layer 102 to form a pocket, in which the inflatable component 104 is situated, that secures the inflatable component 104 to the first layer 102. For the sheet 310, the second layer 122 provides an outer layer of the sheet 310 that covers the pocket formed by the third layer 312. In some embodiments, the inflatable component 104 is clipped to a pocket, such as the pocket formed by the second layer 122 (FIG. 3A) or by the third layer 312 (FIG. 3C).

In some embodiments, the first layer 102 and/or second layer 122 of sheeting includes an absorbent pad (e.g., an incontinence sheet). Alternatively, an absorbent pad is attached to a layer of sheeting. FIG. 3B is a side view of a sheet 300, which has an absorbent pad 302 attached to the second layer of sheeting 122. Alternatively, the absorbent pad 302 is secured (e.g., attached) to the first layer of sheeting 102 of the sheet 120 (FIGS. 1B, 3A) or 100 (FIG. 1A). In some embodiments the absorbent pad 302 is integrated into a layer of sheeting. In some embodiments, the absorbent pad 302 is covered by another layer of sheeting. Examples of absorbent materials used in the absorbent pad 302 include fluff pulp, comminuted wood pulp (generally referred to as airfelt), creped cellulose wadding, absorbent foams, absorbent sponges, super absorbent polymers, absorbent gelling materials, or any equivalent materials or combination of materials. In some embodiments, the absorbent pad 302 includes an absorbent material made of cellulosic fiber, such as, for example, rayon, lyocell, wood pulp, cotton, any superabsorbent, such as, for example, polyacrylate, or some combination of these types of fibers. In some embodiments, the absorbent pad 302 includes a superabsorbent in powder form or granular form.

In some embodiments, the sheet includes an integrated heating pad (e.g., an electric heating pad). For example, a heating pad is attached to a layer of sheeting or is integrated into a layer of sheeting. In some embodiments in which the pump used to inflate the inflatable component is a water pump, warm or hot water is used to inflate the inflatable component to provide heating. In some embodiments, the sheet includes an integrated massage pad; the massage pad may also provide heating.

In some embodiments, the inflatable component includes a plurality of holes (e.g., pinholes) to allow air to escape from the inflatable component when inflated. In some of these embodiments, the layer of sheeting that covers the inflatable component also includes a plurality of holes (e.g., pinholes) through which the air can pass, thus providing airflow to the patient's skin that serves to dry the skin and prevent excessive moisture from macerating the skin. In some embodiments, each hole in the inflatable component and/or sheet is less than 2 mm² in area, or less than 1 mm² in area, or less than 0.5 mm² in area.

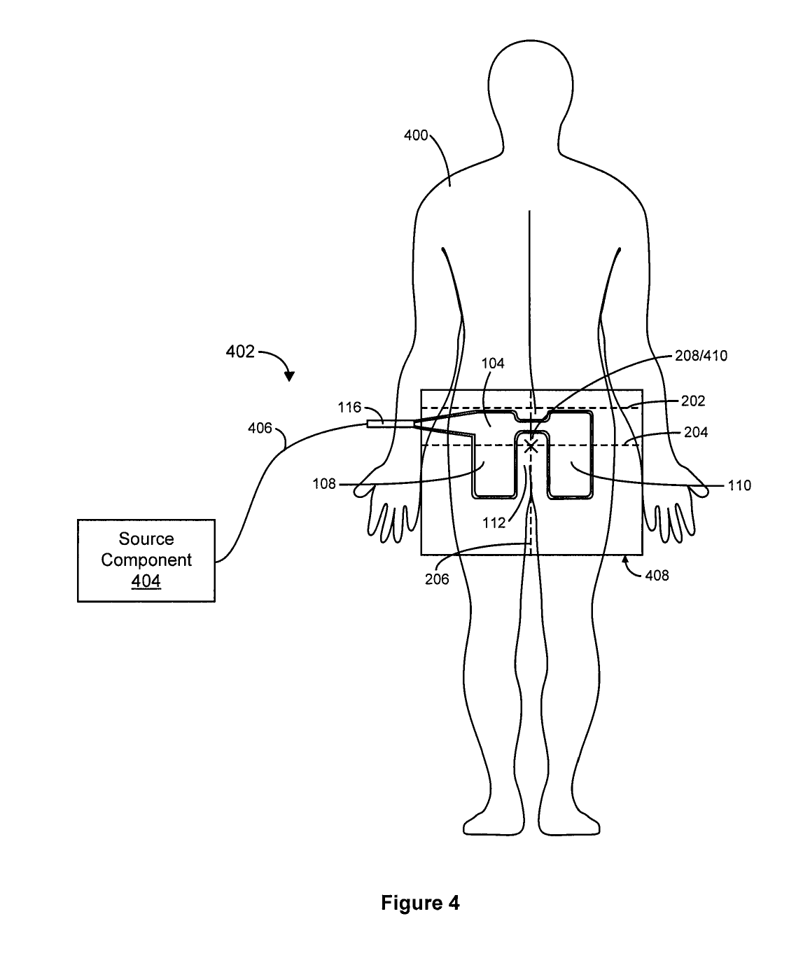

FIG. 4 is a schematic illustration of a system 402 that includes a source component 404 (e.g., an air pump or water pump) coupled to a sheet 408 through tubing 406 in accordance with some embodiments. The tubing 406 connects the source component 404 to the attachment 116 of the inflatable component 104. The sheet 408 corresponds, for example, to the sheet 100 (FIG. 1A), 120 (FIGS. 1B, 3A), 200 (FIG. 2), 300 (FIG. 3B), or 310 (FIG. 3C). As shown in FIG. 4, the sheet 408 is positioned beneath a patient 400 such that the region 112 is positioned under the patient's sacrum 410. The pump repeatedly inflates and deflates the inflatable component 104 via the tubing 406. The line 202 is aligned to the patient's ASIS, such that the line 204 is aligned to the patient's sacrum 410. Also, the line 206 is aligned to the middle of the patient's back and the space between the patient's legs. As a result, the marking 208 and region 112 are positioned under the sacrum 410, and the inflatable component 104 relieves pressure from the sacrum 410 when inflated.

While FIGS. 1-4 illustrate a sheet with an inflatable component 104 that has an H-shape, a sheet can include an inflatable component with any of various shapes and sizes that at least partially enclose a region to be positioned under a portion of the patient's body that is at risk for pressure sores, such that pressure is relieved from the body portion when the inflatable component is inflated. Other examples of suitable shapes include a ring and a U-shape (e.g., a crescent or horseshoe shape). FIG. 5B is a plan view of a U-shaped inflatable component 530 in accordance with some embodiments. The U-shaped inflatable component 530 includes a lateral segment 532 that connects first and second longitudinal segments 534 and 536. The first and second longitudinal segments 534 and 536 are situated on respective opposite sides of the lateral segment 532 and extend longitudinally below (or, alternatively, above) the lateral segment 532, thus forming the U-shape. The segments 532, 534, and 536 partially enclose a region 540 to be positioned under a body portion such that pressure is relieved from the body portion when the inflatable component 530 is inflated. In some embodiments, the inflatable component 530 includes a segment 538, similar to the segment 114 (FIG. 5A), that extends to the edge of the sheet, where it can be attached to tubing.

FIG. 5C is a plan view of a ring-shaped inflatable component 560 in accordance with some embodiments. The ring-shaped inflatable component 560 includes a ring segment 562 and, in some embodiments, a segment 564 similar to the segment 114 (FIG. 5A) and 538 (FIG. 5B). The ring segment 562 encloses a region 540 to be positioned under a body portion body such that pressure is relieved from the body portion when the inflatable component 530 is inflated.

The H-shaped inflatable component 104 (FIG. 5A) offers benefits over the ring-shaped inflatable component 560 (FIG. 5C) and the U-shaped inflatable component 530 (FIG. 5B). Because the ring-shaped inflatable component 560 completely encloses the region 566, it cuts off blood flow to tissue aligned with (e.g., positioned above) the region 566. Similarly, the segments 534 and 536 of the U-shaped inflatable component 530 tend to round off when inflated, such that they enclose or nearly enclose the region 540, thereby cutting off blood flow to tissue aligned with the region 540. The H-shape of the inflatable component 104 helps to ensure that the segments 506 and 508 do not round off when inflated. The region 112 thus remains open on one side, which improves blood flow to tissue aligned with the region 112. A sheet with an H-shaped inflatable component 104 thus provides increased tissue perfusion for the body portion being provided with pressure relief than a sheet with a ring-shaped inflatable component 560 or a U-shaped inflatable component 530. The increased tissue perfusion results in superior healing or prevention of pressure sores.

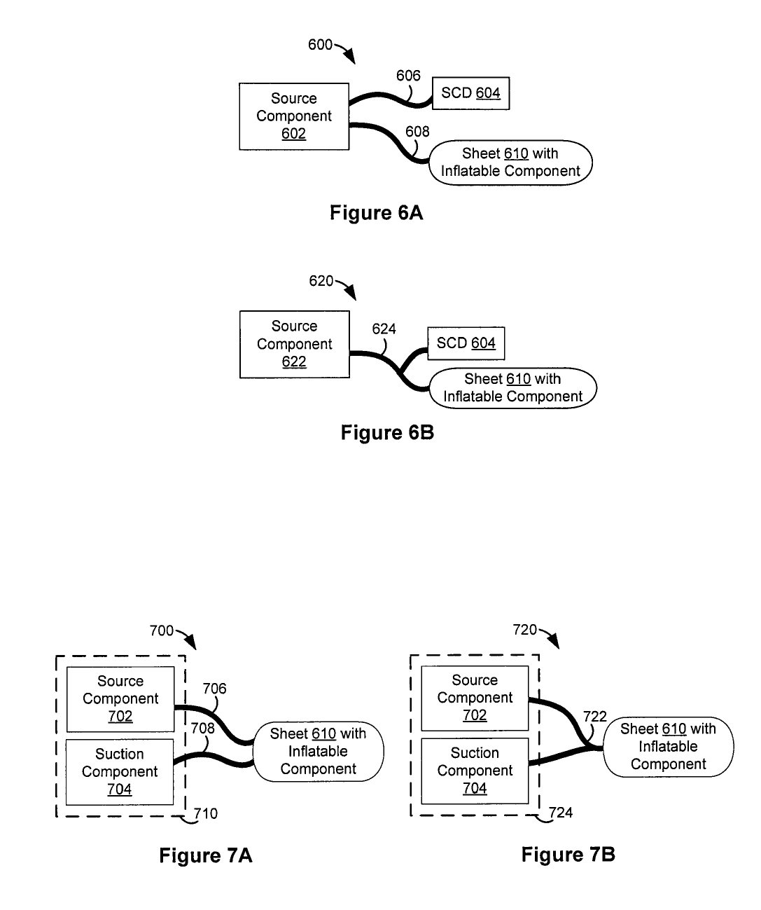

In some embodiments, the pump (e.g., source component 404, FIG. 4) used to inflate and deflate the inflatable component is integrated with one of various types of pumps used in hospital or nursing care settings. For example, the pump may be integrated into a source component (e.g., an air pump) for sequential compression device (SCD) systems used to minimize the risk of deep vein thrombosis. In other words, the source component (air pump or otherwise) may be configured to be connectable to existing SCD systems, such that the source component may provide inflation to both an inflatable component (e.g., 104, 530, or 560, FIGS. 5A-5C) of a sheet (e.g., 100, FIG. 1A; 120, FIGS. 1B & 3A; 200, FIG. 2; 300, FIG. 3B; 310, FIG. 3C; 408, FIG. 4) as well as existing SCDs, as illustrated in the block diagrams of FIGS. 6A and 6B in accordance with some embodiments. In the system 600 of FIG. 6A, a source component 602 provides inflation for an SCD 604 through tubing 606 and provides inflation for a sheet 610 with an inflatable component through separate tubing 608. In some embodiments, the tubing 606 connects to a first connection outlet in the source component 602 and the tubing 608 connects to a second connection outlet in the source component 602. Alternately, in the system 620 of FIG. 6B, the source component 622 provides inflation for the SCD 604 and the inflatable component of the sheet 610 through a single shared tubing 624 that connects to a single connection outlet in the source component 622 and branches to the SCD 604 and sheet 610. The tubing connections for the inflatable component of the sheet 610 thus may be compatible with SCD pumps and an SCD pump may act as the source component 602 or 622 for the inflatable component of the sheet 610.

In some embodiments, the pump is integrated into or combined with a pump for a negative-pressure wound therapy system. In some embodiments, the pump is integrated into or combined with a pump for an air mattress.

In some embodiments, to reduce noise, the source component has a casing made of foam, fiberglass, or other sound insulating or absorbing material.

In some embodiments, the source component (e.g., 404, FIG. 4; 602, FIG. 6A; 622, FIG. 6B) has an electronic system for controlling the intermittent inflation and deflation of an inflatable component (e.g., 104, 530, or 560, FIGS. 5A-5C) of a sheet (e.g., 100, FIG. 1A; 120, FIGS. 1B & 3A; 200, FIG. 2; 300, FIG. 3B; 310, FIG. 3C; 408, FIG. 4). The intermittent inflation and deflation can be timed in any of various ways. The inflation and deflation rates can be rapid or slow. Examples of rapid deflation rates include 5 seconds or less, or 10 seconds or less, while examples of slow deflation rates include at least 2 minutes, or at least 5 minutes, or 10 minutes or more. In some embodiments, the inflation frequency varies from every 5 minutes to every 4 hours. Examples of inflation frequencies include 5-10 minutes, 20 minutes or less, an hour or less, 1-4 hours, or 2-4 hours. In some embodiments, the duration of inflation varies from 30 seconds to 2 hours. Examples of durations of inflation include 1 minute or less, 2 minutes or less, 10 minutes or less, 30 minutes to 2 hours, or 1 to 2 hours. A rapid rate of inflation and deflation produces rapid blood reperfusion to the high-risk area, thus aiding healing or prevention of pressure sores. A lower rate of inflation and deflation, however, is more comfortable to the patient, both because the patient is not subjected to sudden changes and because pump noise is reduced. In some embodiments, the inflation and deflation rates, inflation frequency, and/or duration of inflation are varied depending on the time of day, the condition of the patient, the weight of the patient, a degree or other measure of bed softness, whether the patient is awake or asleep, the patient's position (e.g., supine, prone, lateral decubitus, or tilted), and/or one or more other user-defined conditions. In some embodiments, the inflation and deflation rates, inflation frequency, and/or duration of inflation are programmed to constantly vary to reduce patient discomfort associated with a particular inflation or deflation rate, inflation frequency, or duration of inflation.

In some embodiments, the inflatable component deflates passively. For example, the source component 404 (FIG. 4) vents the inflatable component 104 to atmosphere and the weight of the patient 400 causes the inflatable component 104 to deflate. In some other embodiments, however, a mechanical pump actively deflates the inflatable component. The advantage of active deflation is that it reduces the possibility of creating new pressure points from the inflatable component itself, because the inflatable component is suctioned flat.

In some embodiments, an inflatable component has a tube or tubes that connect to a suction component to provide active deflation. FIG. 7A illustrates a system 700 in which a sheet 610 with an inflatable component is coupled to a source component 702 through a first tubing 706 and a suction component 704 through a second tubing 708 in accordance with some embodiments. FIG. 7B illustrates an alternative system 720 in which a single, branching tubing 722 couples the inflatable component of the sheet 610 to the source component 702 and the suction component 704 in accordance with some embodiments. The source component 702 and suction component 704 may be combined into a single source component 710 (FIG. 7A) or 724 (FIG. 7B) that provides both inflation and active deflation.

In some embodiments, the source component (e.g., 404, FIG. 4; 602/622, FIGS. 6A-6B; 710/724, FIGS. 7A-7B) provides a uniform protocol of inflation and deflation (e.g., level, frequency and/or duration of inflation) optimized to the vast majority of patients. In some embodiments, the source component has one or more pumps that can deliver different (e.g., variable) levels of inflation to the inflatable component. In some embodiments, there is a control panel, one or more switches, or one or more dials that can be used to adjust the function of the source component (e.g., to adjust the level, frequency, and/or duration of inflation). Examples of control panels include but are not limited to a simple dial or an electronic display that may take various inputs (e.g., the patient's body weight or the bed type) to determine the amount of inflation. In some embodiments, for example, the degree of inflation is adjusted via manual or electronic controls for the patient's body habitus (i.e., build), weight, or gender, as well as for characteristics of the mattress the patient is lying upon, such as the mattress type (e.g., mattress manufacturer and model), or characteristics of the chair the patient is sitting upon, such as the type of chair (e.g., manufacturer, and model). In some embodiments, the amount of inflation is determined by using a look-up table that stores inflation values corresponding to different control panel settings. Frequency and duration of inflation may be similarly determined using a look-up table. Alternatively, the level, frequency, and/or duration of inflation may be directly specified using the control panel, switches, and/or dials.

In some embodiments, the inflatable component has a pressure sensor built into it that provides feedback to the source component. In some embodiments the source component can adjust inflation pressures based on the pressure sensor readings to ensure that pressure is alleviated adequately to prevent pressure sore formation. In some embodiments, the pressure sensor is within the source component itself and may adjust to the pressure required for adequate inflation of the elevation component. In some embodiments, the source component includes or is coupled to one or more additional sensors (e.g., temperature, motion, blood oxygen, or pulse sensors).

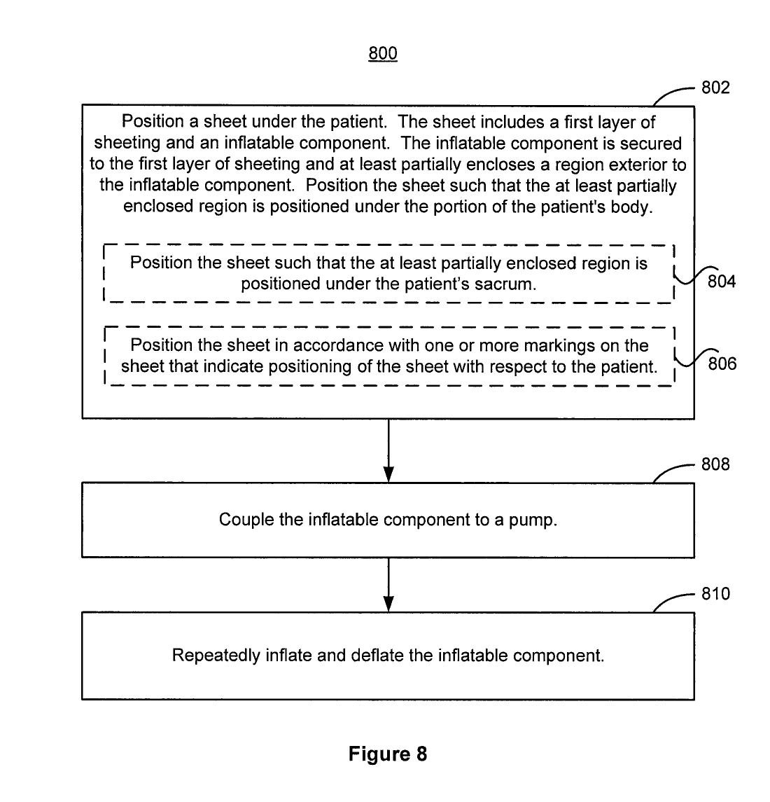

FIG. 8 is a flow diagram illustrating a method 800 of providing pressure relief to a portion of a patient's body to treat or mitigate formation of pressure sores in accordance with some embodiments. In the method 800, a sheet (e.g., 100, FIG. 1A; 120, FIGS. 1B & 3A; 200, FIG. 2; 300, FIG. 3B; 310, FIG. 3C; 408, FIG. 4; 610, FIGS. 6A-7B) is positioned (802) under the patient (e.g., patient 400, FIG. 4). The sheet includes a first layer of sheeting (e.g., first layer 102, FIGS. 1A-4) and an inflatable component (e.g., 104, FIGS. 1A-1B, 2, 4, 5A) (e.g., 530, FIG. 5B; 560, FIG. 5C). The inflatable component is secured to the first layer of sheeting and at least partially encloses a region exterior to the inflatable component (e.g., region 112, FIGS. 1A-5A; region 540, FIG. 5B; region 566, FIG. 5C). The sheet is positioned such that the at least partially enclosed region is positioned under the portion of the patient's body.

In some embodiments, the sheet is positioned (804) such that the at least partially enclosed region is positioned under the patient's sacrum, as illustrated for example in FIG. 4.

In some embodiments, the sheet is positioned (806) in accordance with one or more markings on the sheet (e.g., markings 202, 204, 206, 208, and/or 210, FIG. 2) that indicate positioning of the sheet with respect to the patient.

The inflatable component is coupled (808) to a pump (e.g., source component 404, FIG. 4; 602/622, FIGS. 6A-6B; 710/724, FIGS. 7A-7B) and is repeatedly inflated and deflated (810).

While the method 800 includes a number of operations that appear to occur in a specific order, it should be apparent that the method 800 can include more or fewer operations, the order of two or more operations may be changed, and/or two or more operations may be combined into a single operation.

The foregoing description, for purpose of explanation, has been described with reference to specific embodiments. However, the illustrative discussions above are not intended to be exhaustive or to limit the inventions to the precise forms disclosed. Many modifications and variations are possible in view of the above teachings. The embodiments were chosen and described in order to best explain the principles of the inventions and their practical applications, to thereby enable others skilled in the art to best utilize the inventions and various embodiments with various modifications as are suited to the particular use contemplated.

What is claimed is:

1. A sheet to be positioned under a patient to treat or mitigate formation of pressure sores, the sheet comprising:
a first layer of sheeting; and
an inflatable component secured to the first layer of sheeting, the inflatable component at least partially enclosing a region exterior to the inflatable component, wherein the inflatable component is to relieve pressure from a portion of the patient's body when the at least partially enclosed region is positioned under the portion of the patient's body and the inflatable component is inflated.

2. The sheet of claim 1, wherein the inflatable component is to relieve pressure from the patient's sacrum when the at least partially enclosed region is positioned under the patient's sacrum and the inflatable component is inflated.

3. The sheet of claim 1, wherein:
the first layer of sheeting has a width and a length;
the width of the first layer of sheeting is at least 80 cm; and
the length of the first layer of sheeting is at least 50 cm.

4. The sheet of claim 3, wherein:
the width of the first layer of sheeting is at least 90 cm; and
the length of the first layer of sheeting is at least 60 cm.

5. The sheet of claim 4, wherein:
the length of the first layer of sheeting is at least 90 cm.

6. The sheet of claim 1, wherein the inflatable component is attached to the first layer of sheeting.

7. The sheet of claim 1, further comprising:
a pocket attached to the first layer of sheeting to secure the inflatable component to the first layer of sheeting, wherein the inflatable component is situated in the pocket.

8. The sheet of claim 1, further comprising:
a pocket attached to the first layer of sheeting to secure the inflatable component to the first layer of sheeting, wherein the inflatable component is clipped to the pocket.

9. The sheet of claim 1, further comprising a second layer of sheeting attached to the first layer of sheeting, wherein the inflatable component is situated between the first and second layers of sheeting.

10. The sheet of claim 9, wherein the second layer of sheeting is attached to the first layer of sheeting to form a pocket to secure the inflatable component, wherein the inflatable component is situated in the pocket.

11. The sheet of claim 1, further comprising:
an attachment to couple the inflatable component to tubing for inflating and deflating the inflatable component, the tubing being external to the sheet.

12. The sheet of claim 1, further comprising:
tubing coupled to the inflatable component, for inflating and deflating the inflatable component.

13. The sheet of claim 1, further comprising an absorbent pad, secured to the first layer of sheeting, to be positioned against the patient.

14. The sheet of claim 1, wherein the first layer of sheeting comprises an absorbent pad.

15. The sheet of claim 1, wherein the inflatable component consists essentially of a single inflatable cell.

16. The sheet of claim 1, further comprising an attachment to secure the sheet to an external structure for supporting the patient.

17. The sheet of claim 1, wherein the inflatable component has an “H” shape.

18. The sheet of claim 1, wherein the inflatable component comprises:
a lateral segment;
first and second longitudinal segments, situated on respective opposite sides of the lateral segment and connected by the lateral segment, each comprising a first portion extending longitudinally above the lateral segment and a second portion extending longitudinally below the lateral segment;
wherein the at least partially enclosed region is located between the second portions of the first and second longitudinal segments and is partially enclosed by the lateral segment and the second portions of the first and second longitudinal segments.

19. The sheet of claim 18, wherein:
the lateral segment has a height;
the second portions of the first and second longitudinal segments each have a width; and
the height of the lateral segment is less than the widths of the second portions of the first and second longitudinal segments.

20. The sheet of claim 19, wherein:
the widths of the second portions of the first and second longitudinal segments are at least four inches; and
the height of the lateral segment is three inches or less.

21. The sheet of claim 1, further comprising one or more markings to indicate positioning of the sheet with respect to the patient.

22. The sheet of claim 21, wherein the one or more markings comprise:
a first line extending laterally across the sheet, the first line to be aligned with the patient's anterior superior iliac spine, wherein the first line has a location on the sheet with respect to the at least partially enclosed region that allows the at least partially enclosed region to be aligned to the patient's sacrum when the first line is aligned to the patient's anterior superior iliac spine.

23. The sheet of claim 22, wherein the one or more markings further comprise:
a second line extending laterally across the sheet through the at least partially enclosed region, wherein the second line is separated from the first line by a distance corresponding to an approximate separation of the sacrum and the anterior superior iliac spine.

24. The sheet of claim 23, wherein the distance separating the second line from the first line is 2 to 4 inches.

25. The sheet of claim 23, wherein the distance separating the second line from the first line is 2.8 to 3.2 inches.

26. The sheet of claim 21, wherein the one or more markings comprise:
a third line extending longitudinally across the sheet through the at least partially enclosed region.

27. The sheet of claim 21, wherein the one or more markings comprise:
a line extending laterally across the sheet through the at least partially enclosed region.

28. The sheet of claim 21, wherein the one or more markings comprise:
a marking indicating an area on the sheet to be positioned under the patient's sacrum, the area being located within the at least partially enclosed region.

29. The sheet of claim 21, wherein the one or more markings comprise:
an orientation marking to indicate orientation of the sheet with respect to the patient.

30. A system to provide pressure relief to a portion of a patient's body to treat or mitigate formation of pressure sores, comprising:
a sheet to be positioned under the patient, the sheet comprising:
a first layer of sheeting, and
an inflatable component secured to the first layer of sheeting, the inflatable component at least partially enclosing a region exterior to the inflatable component, wherein the inflatable component is to relieve pressure from the portion of the patient's body when the at least partially enclosed region is positioned under the portion of the patient's body and the inflatable component is inflated;
tubing coupled to the inflatable component; and
a pump, coupled to the tubing, to inflate and deflate the inflatable component.

31. A method of providing pressure relief to a portion of a patient's body to treat or mitigate formation of pressure sores, comprising:
positioning a sheet under the patient, the sheet comprising a first layer of sheeting and an inflatable component, the inflatable component secured to the first layer of sheeting and at least partially enclosing a region exterior to the inflatable component, wherein positioning the sheet comprises positioning the at least partially enclosed region under the portion of the patient's body;
coupling the inflatable component to a pump; and
repeatedly inflating and deflating the inflatable component.
